(19) United States
(12) Patent Application Publication
(10) Pub. No.: US 2011/0273655 A1
(43) Pub. Date: Nov. 10, 2011

(54) Liquid Crystal Display

(75) Inventors: Wen-Tsung Lin, Miao-Li County (TW); Yung-Yu Tsai, Miao-Li County (TW); Ching-Wen Shih, Miao-Li County (TW); Feng-Shuo Kuo, Miao-Li County (TW); Sen-Yi Wang, Miao-Li County (TW); Ming-Shiang Lee, Miao-Li County (TW)

(73) Assignee: CHIMEI INNOLUX CORPORATION, Miao-Li County (TW)

(21) Appl. No.: 13/097,492

(22) Filed: Apr. 29, 2011

(30) Foreign Application Priority Data
May 10, 2010 (TW) 99114813

(51) Int. Cl. G02F 1/1345

(52) U.S. Cl. 349/149

(57) ABSTRACT

A liquid crystal display (LCD) including a backlight module and a liquid crystal panel module is provided. The liquid crystal panel module is disposed at one side of the backlight module. The liquid crystal panel module includes a liquid crystal panel, a first driving circuit board, a second driving circuit board, and a connector. The first driving circuit board has a plurality of first driving chips and a timing controller. The second driving circuit board has a plurality of second driving chips. The first driving circuit board and the second driving circuit board are electrically connected to a same side of the liquid crystal panel. The connector electrically connects the first driving circuit board and the second driving circuit board.

### CROSS-REFERENCE TO RELATED APPLICATION

This application claims the priority benefit of Taiwan application serial no. 99114813, filed on May 10, 2010. The entirety of the above-mentioned patent application is hereby incorporated by reference herein and made a part of this specification.

### BACKGROUND OF THE INVENTION

1. Field of the Invention

The invention generally relates to a display, and more particularly, to a liquid crystal display (LCD).

2. Description of Related Art

In recent years, flat panel displays have been quickly developed along with the maturation of photoelectric technology and semiconductor manufacturing technology. Particularly, LCD has gradually replaced the conventional cathode ray tube (CRT) display as the mainstream product in the display market thanks to its many advantages such as low operation voltage, no radiation, light weight, and small volume.

A conventional technique for driving the liquid crystal panel of a LCD is to transmit a control signal from a control circuit board to a connected driving circuit board through a connector and then drive the connected liquid crystal panel through a driving chip on the driving circuit board. However, since such a structure requires multiple circuit boards and multiple connectors, the material cost and labor cost thereof are very high. Moreover, along with the increase in the size of LCD, a single driving circuit board may be easily deformed or even damaged. Even though this problem can be resolved by disposing two driving circuit boards, the material cost and labor cost of circuit boards and connectors will be further increased.

### SUMMARY OF THE INVENTION

Accordingly, the invention is directed to a liquid crystal display (LCD) with reduced fabrication cost.

The invention provides a LCD including a backlight module and a liquid crystal panel module. The liquid crystal panel module is disposed at one side of the backlight module. The liquid crystal panel module includes a liquid crystal panel, a first driving circuit board, a second driving circuit board, and a first connector. The first driving circuit board has a plurality of first driving chips and a timing controller. The second driving circuit board has a plurality of second driving chips. The first driving circuit board and the second driving circuit board are electrically connected to a same side of the liquid crystal panel. The first connector electrically connects the first driving circuit board and the second driving circuit board.

According to an embodiment of the invention, the number of the first driving chips and the number of the second driving chips may be the same or different.

According to an embodiment of the invention, the first connector is in a straight bar shape, and the first connector may be bent twice. Two ends of the first connector are closer to or farther away from the liquid crystal panel than a central part of the first connector. Two joints of two ends of the first connector are in a straight bar shape, and a length direction of the joints is parallel to, forms an acute angle with, or is perpendicular to the side of the liquid crystal panel.

According to an embodiment of the invention, the first connector is in a U shape.

According to an embodiment of the invention, the liquid crystal panel module further includes a second connector. The first connector and the second connector partially overlap each other. The length of the first connector may be greater than the length of the second connector. The first connector and the second connector may be respectively in a straight bar shape. The first connector and the second connector may be respectively bent twice. Two ends of the first connector are closer to or farther away from the liquid crystal panel than a central part of the first connector, and two ends of the second connector are closer to or farther away from the liquid crystal panel than a central part of the second connector. Four joints of four ends of the first connector and the second connector are in a straight bar shape, and a length direction of the joints is parallel to, forms an acute angle with, or is perpendicular to the side of the liquid crystal panel.

According to an embodiment of the invention, the liquid crystal panel module further includes a second connector. The first connector and the second connector are placed side by side without overlapping each other. The first connector and the second connector may be respectively bent twice.

According to an embodiment of the invention, the liquid crystal panel module further includes a second connector. The first connector and the second connector are respectively bent twice, and the length of the first connector and the length of the second connector are the same.

As described above, in a LCD provided by the invention, a timing controller is integrated with a driving circuit board so that both the labour cost and the material cost spent on the circuit board and the connectors can be reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an explosion diagram of a liquid crystal display (LCD) according to an embodiment of the invention.

FIGS. 2-11 are respectively a diagram of a liquid crystal panel module according to a first to a tenth embodiment of the invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

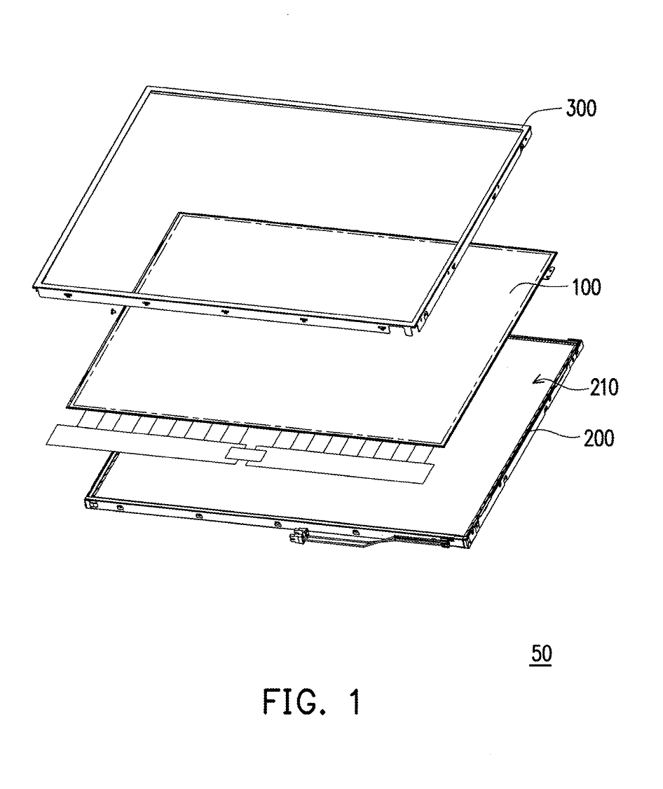

FIG. 1 is an explosion diagram of a liquid crystal display (LCD) according to an embodiment of the invention. Referring to FIG. 1, the LCD 50 in the present embodiment includes a liquid crystal panel module 100 and a backlight module 200. The liquid crystal panel module 100 is disposed at one side of the backlight module 200. To be specific, the liquid crystal panel module 100 is disposed on a light emitting surface 210 of the backlight module 200. In the present embodiment, the backlight module 200 adopts a side-light design. However, when the size of the LCD 50 is 37″ or even larger, the backlight module 200 usually adopts a direct-light design. Besides, the LCD 50 may further have a front frame 300 for steadily disposing the liquid crystal panel module 100 on the backlight module 200. Below, different implementations of the liquid crystal panel module 100 applicable to the LCD 50 will be described.

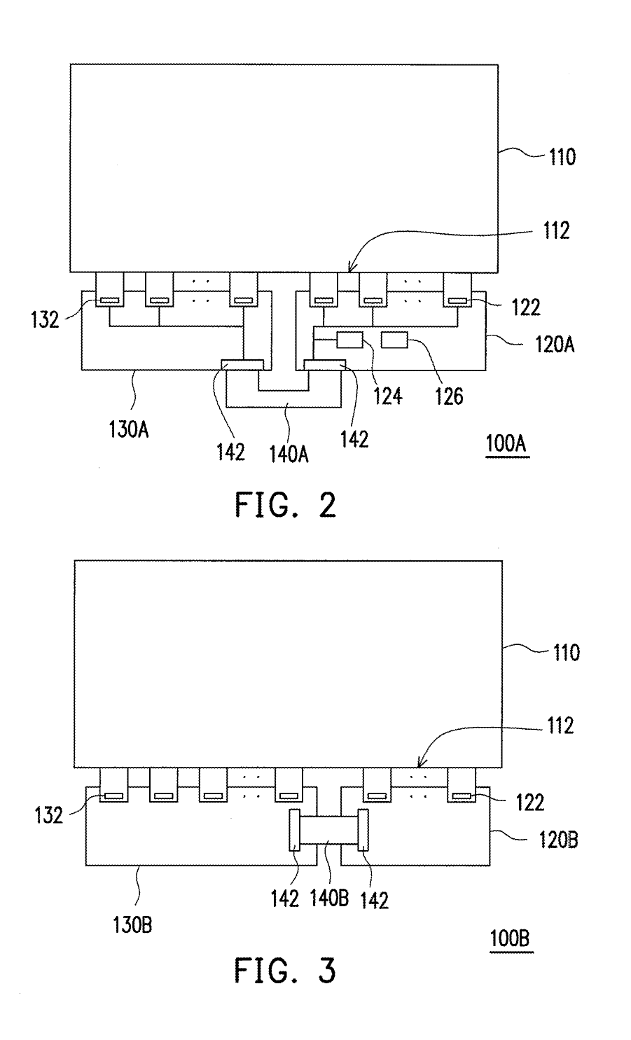

FIG. 2 is a diagram of a liquid crystal panel module according to a first embodiment of the invention. Referring to FIG. 2, the liquid crystal panel module 100A in the present embodiment includes a liquid crystal panel 110, a first driving circuit board 120A, a second driving circuit board 130A, and a first connector 140A. The first driving circuit board 120A has a plurality of first driving chips 122 and a timing controller 124. The second driving circuit board 130A has a plurality of second driving chips 132. Both the first driving circuit board 120A and the second driving circuit board 130A are electrically connected to the side 112 of the liquid crystal panel 110. The first connector 140A electrically connects the first driving circuit board 120A and the second driving circuit board 130A.

Because in the present embodiment, there are two driving circuit boards 120A and 130A, the driving circuit boards won't be deformed or even damaged even if the size of the liquid crystal panel module 100A is very large. In addition, because the timing controller 124 is integrated with the first driving circuit board 120A, the numbers of circuit boards and connectors are reduced and accordingly the material and labor cost spent on circuit boards and connectors are also reduced.

In the present embodiment, all the first driving chips 122 and the second driving chips 132 are configured to drive data lines of the liquid crystal panel 110. However, the first driving chips 122 and the second driving chips 132 may also be configured to drive scan lines or other components of the liquid crystal panel 110. A DC-DC converter chip 126 may be further disposed on the first driving circuit board 120A or the second driving circuit board 130A to provide appropriate working voltages to the timing controller 124, the first driving chips 122, and the second driving chips 132. The first connector 140A in the present embodiment is in a U shape (i.e., the circuit on the first connector 140A also presents a U shape). Two joints 142 at two ends of the first connector 140A are in a straight bar shape, and the length direction of the joints 142 is parallel to the side 112 of the liquid crystal panel 110 so that the widths of the first driving circuit board 120A and the second driving circuit board 130A can be reduced. In the present embodiment, the number of the first driving chips 122 is the same as the number of the second driving chips 132, and the length of the first driving circuit board 120A is approximately the same as the length of the second driving circuit board 130A.

While designing the circuit layouts on the first driving circuit board 120A, the second driving circuit board 130A, and the first connector 140A, the line impedances from the timing controller 124 to each first driving chip 122 and each second driving chip 132 are made close to each other, so as to prevent signal interference and deterioration caused by different line impedances.

FIG. 3 is a diagram of a liquid crystal panel module according to a second embodiment of the invention. Referring to FIG. 3, the liquid crystal panel module 100B in the present embodiment is similar to the liquid crystal panel module 100A illustrated in FIG. 2, and only the differences between the two will be described herein. In the present embodiment, the first connector 140B of the liquid crystal panel module 100B is in a straight bar shape, so that the circuits on the first connector 140B can have the same length and impedance. In addition, the length direction of the two joints 142 at the two ends of the first connector 140B is perpendicular to the side 112 of the liquid crystal panel 110. Moreover, the number of the first driving chips 122 is different from the number of the second driving chips 132, and the length of the first driving circuit board 120B is different from the length of the second driving circuit board 130B.

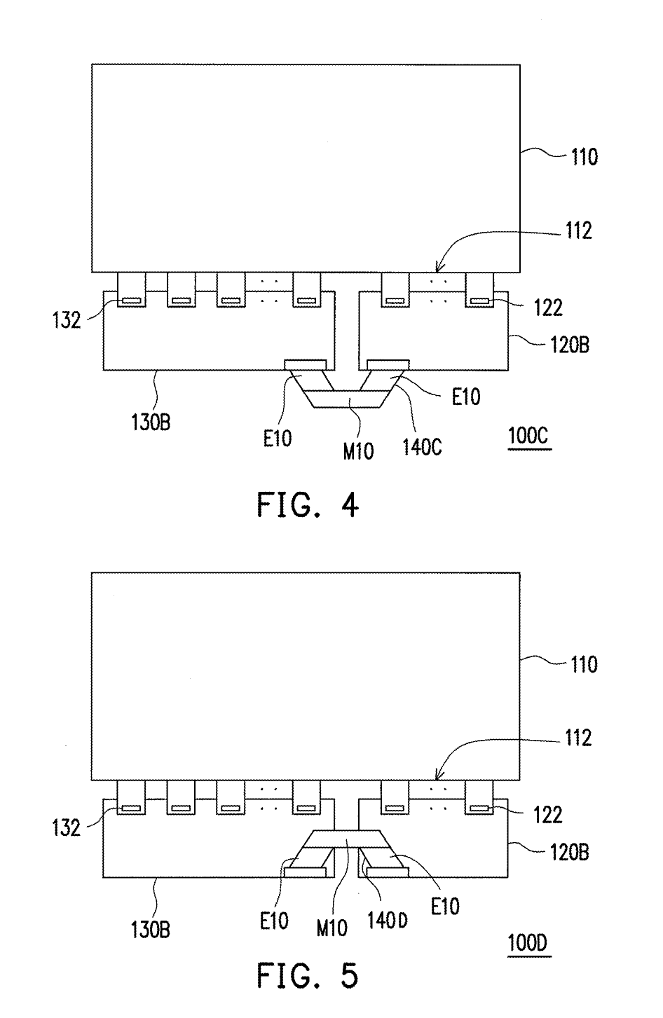

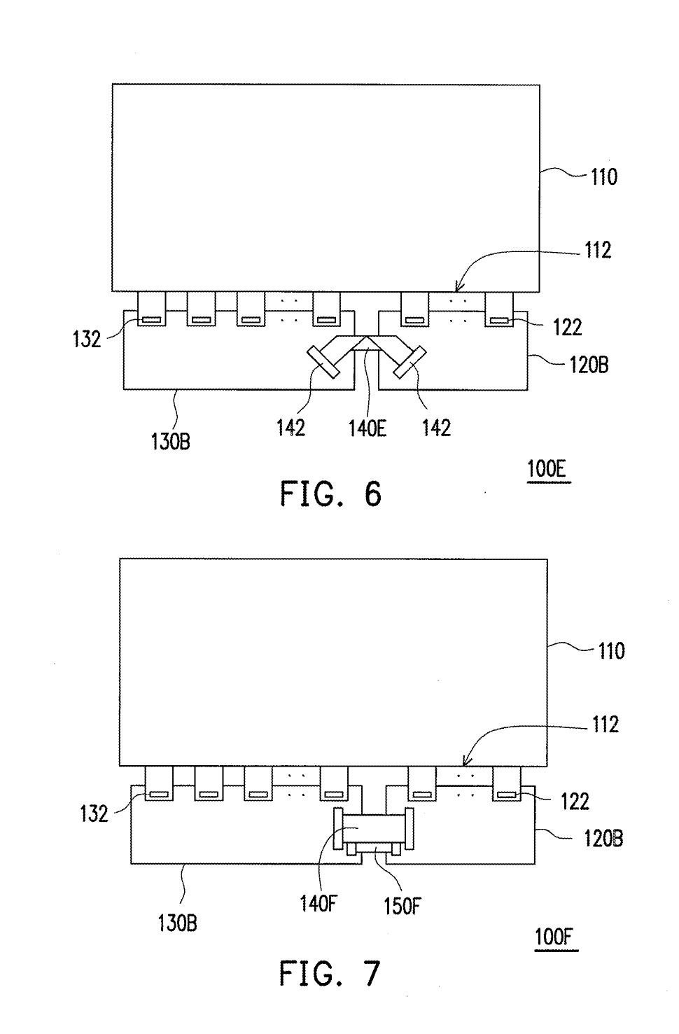

FIGS. 4-6 are respectively a diagram of a liquid crystal panel module according to a third to a fifth embodiment of the invention. Referring to FIG. 4, the liquid crystal panel module 100C in the present embodiment is similar to the liquid crystal panel module 100B illustrated in FIG. 3, and only the differences between the two will be described herein. In the present embodiment, the first connector 140C of the liquid crystal panel module 100C is bent twice. The first connector 140C also presents a straight bar shape before it is bent so that the circuits on the first connector 140C can have the same length and impedance. In addition, the central part M10 of the first connector 140C is farther away from the liquid crystal panel 110 than the two ends E10 of the first connector 140C, so that the first connector 140C is prevented from contacting the liquid crystal panel 110. Referring to FIG. 5, the liquid crystal panel module 100D in the present embodiment is similar to the liquid crystal panel module 100C illustrated in FIG. 4, and only the differences between the two will be described herein. In the present embodiment, the central part M10 of the first connector 140D of the liquid crystal panel module 100D is closer to the liquid crystal panel 110 than the two ends E10 of the first connector 140D so that the first connector 140D is prevented from exceeding the range of the first driving circuit board 120B and the second driving circuit board 130B or being collided during the assembly process. Referring to FIG. 6, the liquid crystal panel module 100E in the present embodiment is similar to the liquid crystal panel module 100D illustrated in FIG. 5, and only the differences between the two will be described herein. In the present embodiment, the two joints 142 at the two ends of the first connector 140E of the liquid crystal panel module 100E are in a straight bar shape, and the length direction of the joints 142 forms an acute angle (for example, 45°) with the side 112 of the liquid crystal panel 110 so that the widths of the first driving circuit board 120B and the second driving circuit board 130B can be appropriately reduced.

FIG. 7 is a diagram of a liquid crystal panel module according to a sixth embodiment of the invention. Referring to FIG. 7, the liquid crystal panel module 100F in the present embodiment is similar to the liquid crystal panel module 100B illustrated in FIG. 3, and only the differences between the two will be described herein. In the present embodiment, the liquid crystal panel module 100F further includes a second connector 150F. The first connector 140F and the second connector 150F overlap each other. In addition, the length of the first connector 140F is greater than the length of the second connector 150F so that the joint between the first connector 140F and the first driving circuit board 120B and the joint between the second connector 150F and the second driving circuit board 130B can be staggered. The first connector 140F and the second connector 150F respectively present a straight bar shape. Since two connectors 140F and 150F are adopted, the widths of the first driving circuit board 120B and the second driving circuit board 130B can be reduced.

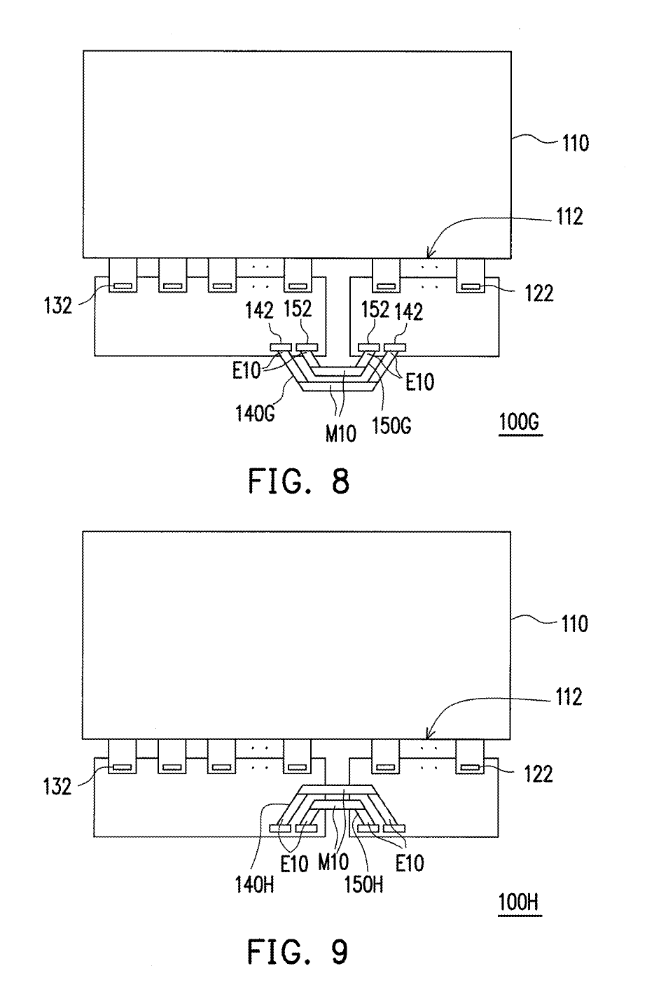

FIGS. 8-11 are respectively a diagram of a liquid crystal panel module according to a seventh to a tenth embodiment of the invention. Referring to FIG. 8, the liquid crystal panel module 100G in the present embodiment is similar to the liquid crystal panel module 100F illustrated in FIG. 7, and only the differences between the two will be described herein. In the present embodiment, the first connector 140G and the second connector 150G of the liquid crystal panel module 100G are respectively bent twice. The first connector 140G and the second connector 150G are also in a straight bar shape before they are bent, so that the circuits on the first connector 140G and the second connector 150G can have the same length and impedance. In addition, two central parts M10 of the first connector 140G and the second connector 150G are farther away from the liquid crystal panel 110 than the four ends E10 of the first connector 140G and the second connector 150G, so that the first connector 140G and the second connector 150G are prevented from contacting the liquid crystal panel 110. The four joints 142 and 152 at four ends of the first connector 140G and the second connector 150G are in a straight bar shape, and the length direction of the joints 142 and 152 is parallel to the side 112 of the liquid crystal panel 110. The first connector 140G and the second connector 150G are disposed side by side without overlapping each other.

Referring to FIG. 9, the liquid crystal panel module 100H in the present embodiment is similar to the liquid crystal panel module 100G illustrated in FIG. 8, and only the differences between the two will be described herein. In the present embodiment, the two central parts M10 of the first connector 140H and the second connector 150H of the liquid crystal panel module 100H are closer to the liquid crystal panel 110 than the four ends E10 of the first connector 140H and the second connector 150H, so that the first connector 140D is prevented from exceeding the range of the first driving circuit board 120B and the second driving circuit board 130B or being collided during the assembly process.

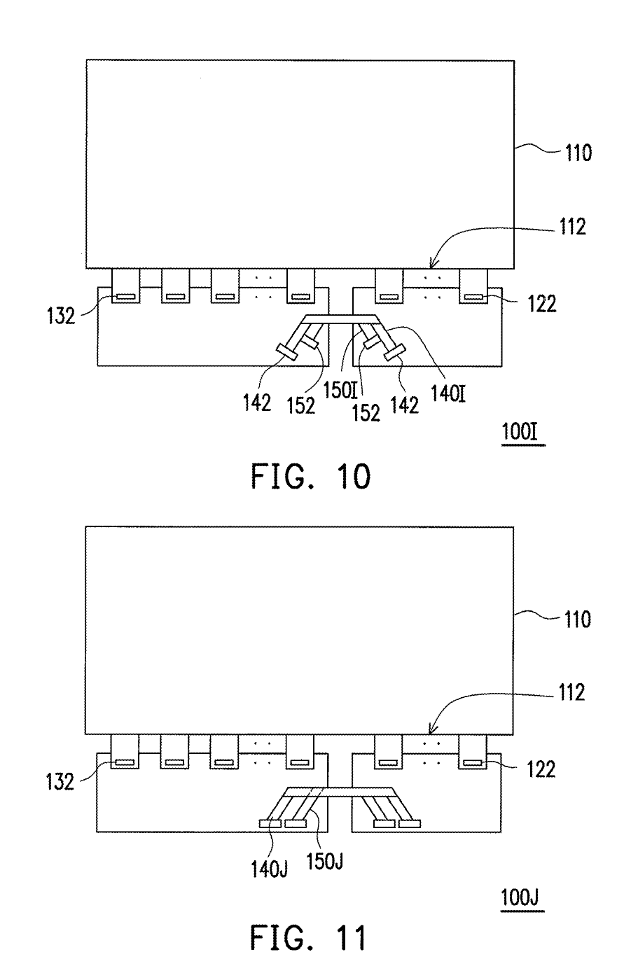

Referring to FIG. 10, the liquid crystal panel module 100I in the present embodiment is similar to the liquid crystal panel module 100H illustrated in FIG. 9, and only the differences between the two will be described herein. In the present embodiment, the two joints 142 and 152 at two ends of the first connector 140I and the second connector 150I of the liquid crystal panel module 100I are in a straight bar shape, and the length direction of the joints 142 and 152 forms an acute angle with the side 112 of the liquid crystal panel 110. In addition, in the present embodiment, the first connector 140I and the second connector 150I overlap each other partially.

Referring to FIG. 11, the liquid crystal panel module 100J in the present embodiment is similar to the liquid crystal panel module 100I illustrated in FIG. 10, and only the differences between the two will be described herein. In the present embodiment, the first connector 140J and the second connector 150J of the liquid crystal panel module 100J have the same length, and the two are disposed side by side and partially overlap each other.

In summary, in a LCD provided by the invention, two driving circuit boards are adopted so that the driving circuit boards won't be deformed or even damaged due to the affection of gravity. In addition, the timing controller is integrated with one of the driving circuit boards so that the numbers of circuit boards and connectors are reduced and accordingly the material and labor cost is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A liquid crystal display (LCD), comprising:
a backlight module;
a liquid crystal panel module, disposed at one side of the backlight module, the liquid crystal panel module comprising:
a liquid crystal panel;
a first driving circuit board, having a plurality of first driving chips and a timing controller;
a second driving circuit board, having a plurality of second driving chips, wherein the first driving circuit board and the second driving circuit board are electrically connected to a same side of the liquid crystal panel; and
a first connector, electrically connecting the first driving circuit board and the second driving circuit board.

2. The LCD according to claim 1, wherein a number of the first driving chips is the same as a number of the second driving chips.

3. The LCD according to claim 1, wherein a number of the first driving chips is different from a number of the second driving chips.

4. The LCD according to claim 1, wherein the first connector is in a straight bar shape.

5. The LCD according to claim 4, wherein the first connector is bent twice.

6. The LCD according to claim 5, wherein two ends of the first connector are closer to the liquid crystal panel than a central part of the first connector.

7. The LCD according to claim 5, wherein two ends of the first connector are farther away from the liquid crystal panel than a central part of the first connector.

8. The LCD according to claim 5, wherein two joints of two ends of the first connector are in a straight bar shape, and a length direction of the joints is parallel to the side of the liquid crystal panel.

9. The LCD according to claim 5, wherein two joints of two ends of the first connector are in a straight bar shape, and a length direction of the joints forms an acute angle with the side of the liquid crystal panel.

10. The LCD according to claim 5, wherein two joints of two ends of the first connector are in a straight bar shape, and a length direction of the joints is perpendicular to the side of the liquid crystal panel.

11. The LCD according to claim 1, wherein the first connector is in a U shape.

12. The LCD according to claim 1, wherein the liquid crystal panel module further comprises a second connector, and the first connector and the second connector partially overlap each other

13. The LCD according to claim 12, wherein a length of the first connector is greater than a length of the second connector.

14. The LCD according to claim 12, wherein the first connector and the second connector are respectively in a straight bar shape.

15. The LCD according to claim 14, wherein the first connector and the second connector are respectively bent twice.

16. The LCD according to claim 15, wherein two ends of the first connector are closer to the liquid crystal panel than a central part of the first connector, and two ends of the second connector are closer to the liquid crystal panel than a central part of the second connector.

17. The LCD according to claim 15, wherein two ends of the first connector are farther away from the liquid crystal panel than a central part of the first connector, and two ends of the second connector are farther away from the liquid crystal panel than a central part of the second connector.

18. The LCD according to claim 15, wherein four joints of four ends of the first connector and the second connector are in a straight bar shape, and a length direction of the joints is parallel to the side of the liquid crystal panel.

19. The LCD according to claim 15, wherein four joints of four ends of the first connector and the second connector are in a straight bar shape, and a length direction of the joints forms an acute angle with the side of the liquid crystal panel.

20. The LCD according to claim 15, wherein four joints of four ends of the first connector and the second connector are in a straight bar shape, and a length direction of the joints is perpendicular to the side of the liquid crystal panel.

21. The LCD according to claim 1, wherein the liquid crystal panel module further comprises a second connector, and the first connector and the second connector are placed side by side without overlapping each other.

22. The LCD according to claim 21, wherein the first connector and the second connector are respectively bent twice.

23. The LCD according to claim 1, wherein the liquid crystal panel module further comprises a second connector, the first connector and the second connector are respectively bent twice, and a length of the first connector and a length of the second connector are the same.
